(19) United States
(12) Patent Application Publication
(10) Pub. No.: US 2012/0026294 A1
(43) Pub. Date: Feb. 2, 2012

(54) DISTANCE-MEASURING OPTOELECTRONIC SENSOR FOR MOUNTING AT A PASSAGE OPENING

(75) Inventors: Bernd ROTHENBERGER, Breisach (DE); Manfred HABERER, Riegel (DE)

(73) Assignee: SICK AG, Waldkirch (DE)

(21) Appl. No.: 13/170,223

(22) Filed: Jun. 28, 2011

(30) Foreign Application Priority Data
Jul. 30, 2010 (DE) 10 2010 036 775.3

(51) Int. Cl. H04N 13/02; H04N 7/18

(52) U.S. Cl. 348/46; 348/140; 348/E07.085; 348/E13.074

(57) ABSTRACT

A distance measuring optoelectronic sensor (10) for mounting at a passage opening (40) is provided which is designed to acquire depth-resolved image information of that object section of an object (48) moved through the passage opening (40) which is in each case located in the detection zone of the sensor (10), having a memory unit (32) which holds known objects and their reference contour information as well as having an evaluation unit (30) which is designed to compare the image information and the reference contour information to decide whether an object (48) to be checked which is located in the passage opening (40) is permitted there, wherein the sensor (10) has a safety output (34) via which a securing signal can be output if the object (48) to be checked is not in the passage opening (40). In this respect, the evaluation unit (30) is designed to note for each known object (50) stored in the memory unit (32) whether it could be the object (48) to be checked and in each case during the movement of the object (48) through the passage opening (40) to exclude such known objects (50) in which the comparison of the image information and of the reference contour information results in differences beyond a tolerance threshold, with no securing signal being output for so long as at least one known permitted object (50) still comes into consideration for the object (48) to be checked.

The invention relates to a distance measuring optoelectronic sensor for mounting at a passage opening in accordance with the preamble of claim 1 as well as to a method for securing a passage opening in accordance with the preamble of claim 14.

It is frequently necessary in industrial production processes to convey objects to be processed, for example a vehicle body, automatically from a zone not dangerous for persons into a dangerous zone or vice versa. The access of persons must be reliably prevented during the processing steps in the dangerous zone. For this purpose, optoelectronic sensors such as safety light barriers or safety light grids can be used at the passage to the dangerous zone. The further processing is immediately interrupted to prevent accidents when a person enters into the entry zone or exit zone.

Distance measuring sensors are suitable for an intelligent securing which not only recognize the mere object intrusion into a protected zone, but also provide additional data such as the location of the entry or object contours. For this purpose, the sensor measures the distance between the sensor and the respective detected object point and thus produces depth-resolved image information.

The distance measuring sensors include safety laser scanners such as described in DE 43 40 756 A1. In this respect, a light beam generated by a laser periodically sweeps over a monitored zone with the help of a deflection unit. The light is remitted at objects in the monitored zone and is evaluated in the scanner. A conclusion is drawn on the angular pulsation of the object from the angular position of the deflection unit and additionally on the distance of the object from the laser scanner from the time of flight while using the speed of light. The location of an object in the monitored zone and the contour of the object can be determined using the angular data and the distance data. In this respect, two general principles are known to determine the time of flight. In phase-based processes, the transmitted light is modulated and the phase shift of the received light with respect to the transmitted light is evaluated. In pulse-based processes, such as are preferably used in safety technology, the laser scanner measures the time of flight until a transmitted light pulse is received again.

Another distance measuring sensor family is represented by 3D cameras which take three-dimensional distance images in which therefore distance information or depth information is acquired in addition to a flat image. 3D cameras use different processes. One of them is stereoscopy. In this respect, images of the scene are acquired from slightly different perspectives. Structures which are the same are identified in the overlapping image zones and distances are calculated from the disparity and the optical parameters of the camera system by means of triangulation and thus a three-dimensional image or a depth map (disparity map) is calculated. A further process used in time of flight cameras comprises determining the time of flight up to the objects in the monitored scenery for each pixel and to acquire the depth information from it. This can take place by transmitting intensity-modulated light and phase measurement on which, for example, photomixing detection is based or also by direct time of flight measurement of a light pulse. The basic principle of the distance measurement of a time of flight camera thus corresponds to the laser scanner, only that the time of flight is measured a multiple of times for the individual pixels of the camera. There are also further 3D camera processes, for instance the light cut processes.

Sensors used in safety technology have to work particularly reliably and must therefore satisfy high safety demands, for example the EN13849 standard for safety of machinery and the machinery standard EN61496 for electrosensitive protective equipment (SSPE). A corresponding standard for safe cameras is being prepared. A number of measures have to be taken to satisfy these safety standards such as reliable electronic evaluation by redundant, diverse electronics, function monitoring or specifically monitoring the soiling of optical components, in particular of a front screen, and/or provision of individual test targets with defined degrees of reflection which have to be recognized at the corresponding scanning angles.

In the initially named securing of a passage to a dangerous zone using optoelectronic sensors, it must be ensured that the objects to be processed can reach and leave the working zone without triggering a safety-directed emergency stop. It is known to deactivate the sensors for a time for this purpose (muting). However, this requires additional sensors to recognize when the safety sensor has to be muted or requires a signal from the transport system. This causes a correspondingly high effort for the configuration, wiring and putting into operation of the muting station. In addition, it is frequently possible relatively simply to penetrate into the dangerous zone unrecognized just before or after the object or at its side.

Alternatively to a securing using sensors, mechanical means are used, for instance, fast-running gates, swing flaps or mechanical silhouettes. However, they do not solve the problem of persons entering with the permitted object. A silhouette, for example, necessarily has to be matched to the largest permitted object and thus provides a safety gap with respect to smaller objects.

A laser scanner is known from DE 44 11 448 B4 for the control of a defined monitored zone which determines a distance contour of objects located in the monitored zone. This distance contour is compared with a plurality of stored reference contours which correspond to expected objects within the monitored zone. If an object located in the monitored zone is recognized as permitted in accordance with this comparison, no deactivation signal is output. In the conventional procedures, however, all stored reference contours constantly have to be compared with the object located in the monitored zone. This is relatively complex and/or expensive and in addition no information on previous comparisons is included if the same object has already been checked in an earlier movement stage. The monitoring thereby becomes slow and prone to error.

DE 10 2004 973 A1 discloses a control of a monitored zone at a transport device. A contour search is carried out at object points produced by a laser scanner to determine whether a defined model line of an article permitted in the monitored zone can be recognized. If this is not possible it is evaluated as a safety-relevant object intrusion and a deactivation signal is output. In this manner, for example, paper rolls with their characteristic round contour can be recognized as permitted. For general objects, a model line is not a sufficient basis for a reliable check.

It is therefore an object of the invention to provide a simple and flexible safety system for the securing of a passage which allows both the fast classification and the permissibility check of objects moved through.

This object is satisfied by a distance-measuring optoelectronic sensor in accordance with claim 1 and by a method for securing a passage opening in accordance with claim 14. In this respect, the invention starts from the basic idea of evaluating objects in the passage opening with reference to stored known objects. For this purpose, it is first assumed for the finite number of known, permitted objects that they correspond to an object to be checked in the passage opening. As long as this assumption can still be maintained for at least one of the known objects, no securing of the passage opening takes place. A securing only takes place as soon as the last object known as permitted has also been excluded by comparison of the image information of the object to be checked with reference contour information of the known objects.

The invention has the advantage that the object is simultaneously also identified on a detection of an object in the passage opening. In addition to the securing, a 3D verification of objects and object surfaces is made possible. Unlike with muting stations, no additional sensor systems are required. The intrusion of persons is also reliably recognized when they attempt to pass through the passage opening together with an object permitted per se. A particularly fast and reliable recognition takes place by the constant exclusion of known objects no longer to be considered which also utilizes prior information detected during the movement.

It is generally conceivable also to carry out a comparison with unpermitted known objects. As soon as all permitted known objects have been excluded for an object to be checked, the securing takes place.

The currently detected image information of the object section of an object to be checked located in the detection zone is used for the comparison of image information with reference contour information. In addition, however, image information of an object section of the same object detected in an earlier movement stage can also be used.

The tolerance threshold of the comparison between image information and reference contour information is set in dependence on the application. The difference must be smaller than the smallest object whose intrusion is to be prevented, that is, for example, smaller than a person or than a human body part.

The evaluation unit is preferably designed to preclude known objects as corresponding to the object to be checked in a pre-section in advance. The correspondence of an object to be checked to a known object is thus not excluded for all known objects on the basis of a comparison of the image information with reference contour information. Instead, only a pre-selection of known objects which can be considered at all remains for this check. The effort for the comparison is thus reduced and the recognition safety is further increased. In the extreme case, only a single pre-selected object remains.

The evaluation unit is particularly preferably designed to make the pre-selection independently of image information of the object to be checked. The pre-selection in this respect utilizes independent pre-knowledge; for example, knows the objects to be expected from the production routine or a pre-positioned sensor already detects in advance the objects to be checked and so excludes specific known objects.

The evaluation unit is advantageously designed to determine a degree of correspondence in the comparison of the image information and of the reference contour information. A probability that the object to be checked is this known object can be derived from this for all known objects. This enables relative comparisons in the classification of the object to be checked and diagnoses.

The evaluation unit is particularly preferably designed to exclude all other known objects on exceeding of a minimum similarity threshold of the degree of correspondence for a known object. This corresponds to a winner takes all strategy in the classification, wherein the most probable known object excludes all other known objects. This procedure is particularly suitable briefly after the intrusion of the object into the passage opening. A type of pre-section is thus ultimately made which is, however, already based on the image information of the sensor. To force an exceeding of the minimum similarity threshold briefly after the penetration, the minimum similarity threshold can be slowly lowered after a first detection of an object to be checked or the minimum similarity threshold is defined relatively.

The evaluation unit is preferably designed to take account of displacements and/or rotations between the known object and the object to be checked in the comparison of the image information with the reference contour information. A higher flexibility thus arises, especially when the objects do not pass through the passage opening with compulsory guidance. The location and rotational position of the object to be checked known in this manner can moreover be utilized in subsequent processing steps.

A speed sensor is preferably provided to determine the movement profile of the object through the passage opening or a movement profile of the object is preset for the evaluation unit. The latter applies, for example, at a conveyor whose conveying behavior is known or can be output by a conveyor control. The movement profile is frequently only a uniform movement in one direction, but more complicated movement profiles can also be processed. The degrees of freedom in the association of the image information with the reference contour information are considerably reduced by the known movement profile and this results in a faster and more robust evaluation. This applies in particular to objects to be checked which are not subject to compulsory guidance where the recognition of the location and rotational position is considerably simplified due to the constraints known by the movement profile.

The evaluation unit is preferably designed for a teaching mode in which objects are moved through the passage opening which are then stored as known objects in the memory unit with reference contour information produced from image information recorded during the movement. The database of the known objects is thus initially prepared in a simple manner or is expanded at any time. No programming knowledge is required for this purpose.

The sensor preferably has an input for a transit signal via which time sections can be signaled in which no permitted objects are to be expected in the passage opening. The usual interval between conveyed articles can, for example, be defined at a conveyor. Intrusions between two such objects are then not permitted independently of the object contour. The sensor can therefore, for example, fully cancel the contour comparison in these time intervals between two possible permitted objects and can respond to any object intrusion into the passage opening by a warning or by a securing.

The evaluation unit is preferably designed to store the image information of a respective object section and thus to compose image information of object portions piece-by-piece which have already passed through the passage opening. This procedure has the result, for example with a two-dimensional scanner, that the scan planes taken at different points in time are compiled slice-by-slice to form a three-dimensional total contour of the object portion previously moved through the passage opening. On the basis of a determination of the location and rotational position, a 3D model of the object to be checked thus arises which is substantially more precisely comparable with the reference contour information than an only two-dimensional slice which is currently located in the detection zone.

An object output or a display is advantageously provided to output all known objects still to be considered as the object to be checked and/or the most probable known object for an object moved through the passage opening. The identity of the object to be checked can thus be monitored or can be utilized for other processing steps.

The sensor is preferably designed as a laser scanner and has a light transmitter for transmitting a light beam into the passage opening, a light receiver for generating a reception signal from the light beam remitted by objects in the passage opening as well as a movable deflection unit for periodically scanning the passage opening. A plurality of mutually connected scanners are also conceivable which mutually complement one another in their angles of view and their positions.

The sensor is alternatively designed as a 3D camera. In this respect, different 3D processes can be considered, for example a stereo camera having two image sensors and a stereoscopic unit in which a stereoscopic distance calculation can be carried out from image data of the two image sensors or a time of flight camera having a light transmitter, an image sensor and a time of flight measuring unit by means of which a time of flight between the transmission of a light beam by the light transmitter and the registration of the light beam in the pixel can be determined for each pixel of the image sensor. This 3D camera has one or more image sensors with pixels arranged to form a matrix. Only linear image sensors are also conceivable. The detection zone is then a plane analog to the scan plane of a laser scanner. During the relative movement with respect to the object, this plane successively detects the total three-dimensional object contour.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

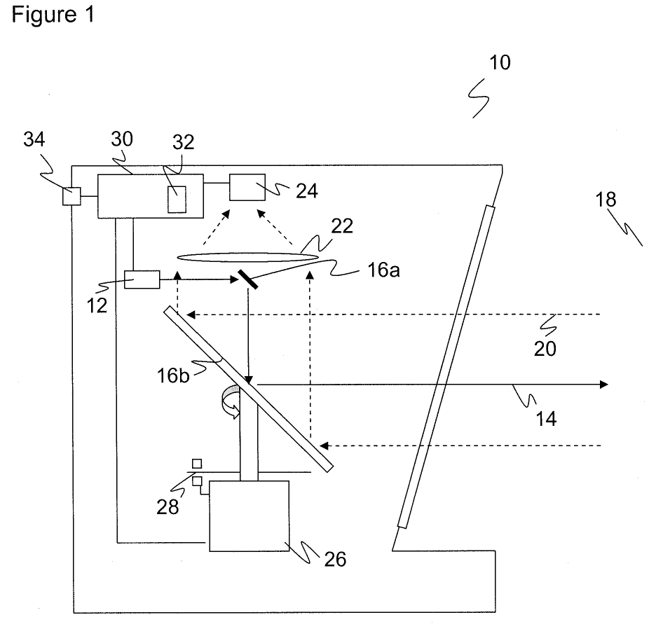

FIG. 1 a sectional representation of a laser scanner as an example for a distance measuring optoelectronic sensor in accordance with the invention;

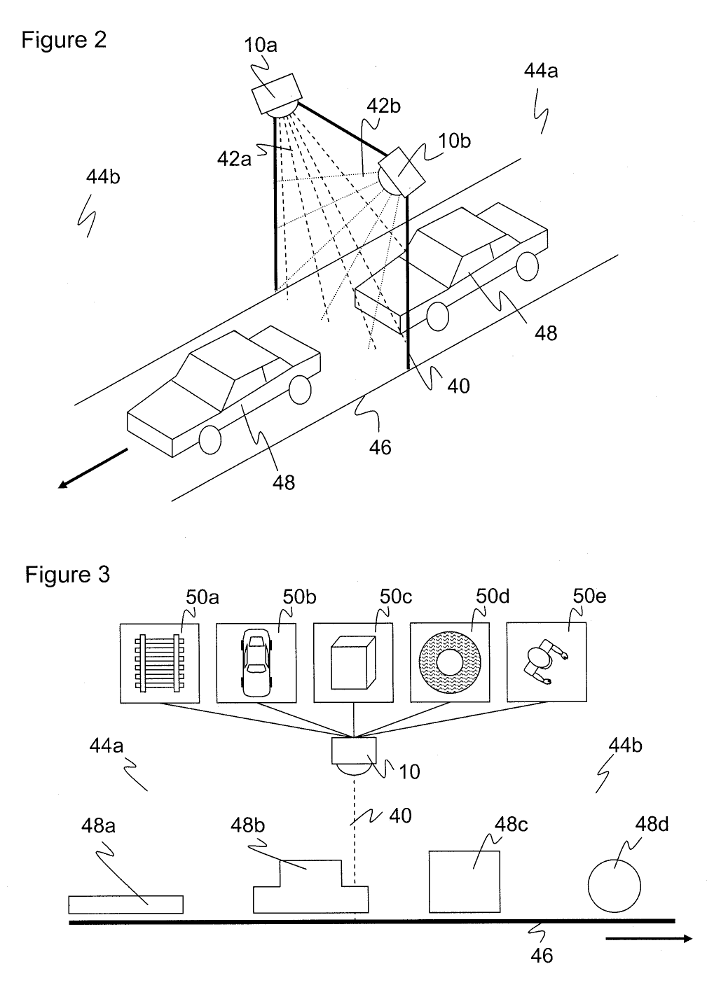

FIG. 2 a three-dimensional view of a passage opening in which sensors in accordance with FIG. 1 are mounted;

FIG. 3 a side view of a passage opening for illustrating the detection and classification in accordance with the invention of permitted objects; and

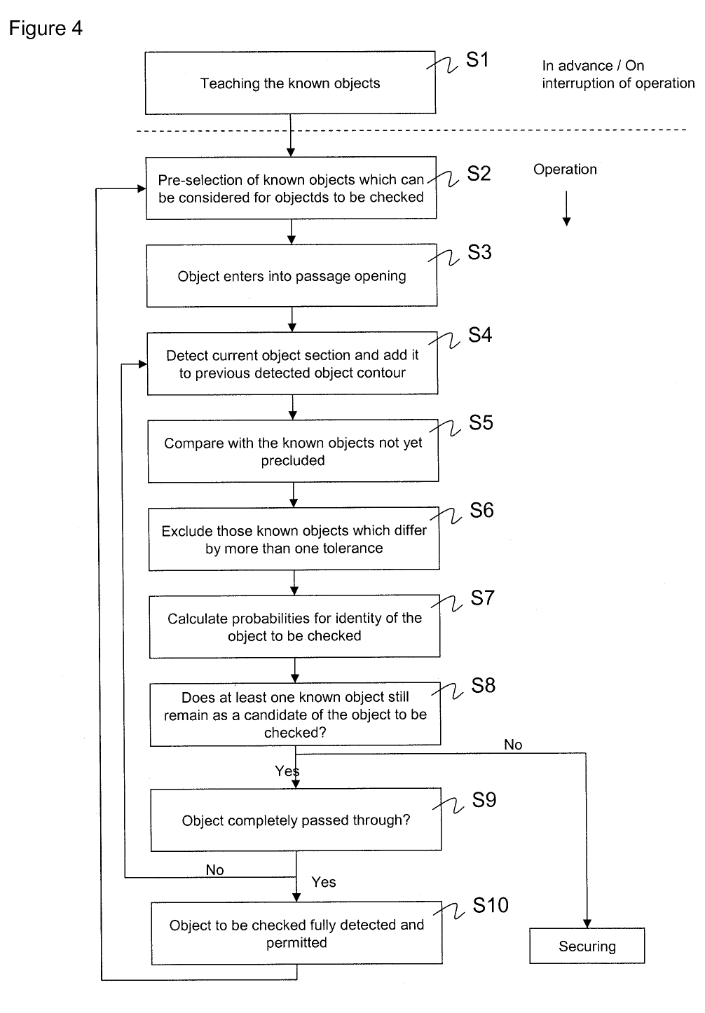

FIG. 4 a flowchart for explaining the detection and classification.

FIG. 1 shows a schematic sectional representation through an optoelectronic sensor in accordance with the invention which is designed by way of example as a safety scanner 10. Alternatively, the sensor can also be one of the other distance measuring sensors named in the introduction. A light beam 14 which is generated by a light transmitter 12, for example by a laser, and which has individual light pulses is directed into a monitored zone 18 via light deflection units 16a-b and is there remitted by an object which may be present. The remitted light 20 again arrives back at the safety scanner 10 and is detected there by a light receiver 24, for example a photodiode, via the deflection unit 16b and by means of an optical receiving system 22.

The light deflection unit 16b is made as a rule as a rotating mirror which rotates continuously by the drive of a motor 26. The respective angular position of the light deflection unit 16b is detected via an encoder 28. The light beam 14 generated by the light transmitter 12 thus sweeps over the monitored zone 18 generated by the rotational movement. If a reflected light signal 20 received by the light receiver 24 is received from the monitored zone 18, a conclusion can be drawn on the angular position of the object in the monitored zone 18 from the angular position of the deflection unit 16b by means of the encoder 28.

In addition, the tight of flight of the individual laser light pulses is determined from their transmission up to their reception after reflection at the object in the monitored zone 18. A conclusion is drawn on the distance of the object from the safety scanner 10 from the time of flight while using the speed of light. This evaluation takes place in an evaluation unit 30 which is connected for this purpose to the light transmitter 12, to the light receiver 24, to the motor 26 and to the encoder 28. Two-dimensional polar coordinates of all object points in the monitored zone 18 are thus available via the angles and the distance as distance-resolved image information of the contour of the object directed to the safety scanner 10.

The evaluation unit 30 detects objects in the monitored zone 18 with reference to the image information in a manner to be described further below with reference to FIGS. 2 to 4 and decides whether these objects are permitted or not with reference to reference data in a memory 32. If a non-permitted object is recognized, the safety scanner 10 outputs a safety-directed deactivation signal via a secure output 34 (OSSD, output signal switching device). Alternatively, this object recognition takes place in an external evaluation unit, not shown. The output 34 or an additional output, not shown, then makes possible the output of image information to the external evaluation unit.

FIG. 2 shows in a three-dimensional representation the mounting of two safety laser scanners 10a, 10b at a passage opening 40. The scan planes 42a-b of the two safety laser scanners 10a-b are shown by dashed and dotted lines respectively and cover the passage opening 40. The safety laser scanners 10a-b are connected to one another and are mutually registered so that the image information can be evaluated in a common global coordinate system. The combination of the safety laser scanners 10a-b thus effectively behaves, from a functional aspect, as a single sensor with an improved visual zone. Differently, only one signal sensor can also be mounted, for example centrally, in the passage opening 40, or additional sensors are used for the again improved detection of the passage opening 40.

The passage opening 40 separates a zone 44a of a conveying system 46 from a zone 44b. A passage through the passage opening 40 should only be allowed for specific objects 48. If the safety laser scanners 10a-b recognize another object, in particular a person, a securing is initiated in order, for example, to set the conveying system 46 or processing machines in one of the zones 44a-b to a standstill. The conveying system 46 does not necessarily have to be guided in a track. The invention can also be used at a passage opening 40 at which objects move freely.

FIG. 3 shows the passage opening 40 in a side view. The object 48b which is just located in the passage opening 40 is checked for permissibility in the zone 44b using the process explained forthwith reference to FIG. 4. In summary, for this purpose, reference contours of possible objects 50a-e in the safety scanner 10 are stored in a database. During the passage of the object 48b, the contour of the object section currently detected by the safety scanner 10 and object sections previously detected during the movement are compared with the reference contours. A securing then only takes place when all known permitted objects 50a-d are excluded on the basis of this comparison. The object 50e is an example for a non-permitted known object: As soon as only non-permitted known objects 50e can be considered for the object 48b to be checked, a securing likewise takes place.

FIG. 4 shows a flowchart of the object detection and object classification in the evaluation unit 30. In a first step S1, the database of known objects 50a-e is prepared in advance and is stored in the memory 32. For this purpose, each object 50a-e passes through the passage opening 40 in a teaching mode. An identification, for example a name, and information on the permissibility are stored for each of the objects 50a-e. In the example of FIG. 3, the pallet 50a, the vehicle body 50b, the box 50c and the wheel 50d are permitted objects, whereas the person 50e is not permitted. The safety scanner 10 furthermore detects the object contour slice by slice during the passing through so that the required reference contour information on each object 50a-e are also stored in the database. An additional teaching of further objects 50a-e is also possible later during operating interruptions. This is also required when the objects 50a-e change over the course of time, for instance due to a new production start.

In an optional second step S2, a pre-selection from the known objects 50a-e is made for an arriving object 48b to be checked. It may, for example, be known from the production procedure that only specific objects 50a-e or even only a single object 50a-e is/are to be expected. Error sources of the detection are then eliminated by restriction of the known objects 50a-e and the evaluation is accelerated. The pre-selection can take place both for the total operation and only for individual or several expected objects 48a-d.

An object 48b to be checked then enters into the detection zone of the safety scanner 10 during the operation in a third step S3.

The object contour of the object section within the passage opening 40 is detected in a fourth step S4 and is added to an object contour detected since the entry of the object 48b into the passage opening. Alternatively, no assembly of the individual detections takes place, but rather work is respectively only carried out using the currently taken image data of the object 48b. It is required for the detection that the surface property of the objects 48a-d allows a laser scanner measurement. Furthermore a maximum speed of the objects 48a-d is assumed so that the laser scanner can perform the scanning without geometrical undersampling in the direction of movement.

This detected object contour is compared in a fifth step S5 in real time with the reference contour of all known objects 50a-e of the database which can still be considered for the identity of the object 48b to be checked. These are all known objects 50a-e which have not yet been excluded either due to a pre-selection in step S2 or due to a comparison with a reference contour which had failed at an earlier point in time. The position on the known object 50a-e is estimated for the comparison. For this purpose, a particle filter having auxiliary conditions or a correlator is used, for example. Any desired stop-and-go operation is thereby possible.

The contour examination takes place in a sixth step S6 at the estimated position of the known object 50a-e with respect to a tolerance threshold. If the currently detected data of the object 48b do not match the known object 50a-e, that is if they differ from one another by more than the tolerance limit, the respective differing known object 50a-e is excluded as a candidate for the identity of the object 48b to be checked. Generally, three degrees of freedom of translation and three degrees of freedom of rotation are to be considered in the comparison. Constraints can be assumed to limit the required calculation effort. A fixed transport height, for example, fixes the degree of freedom of the translation in the vertical direction. Further restrictions can be carried out by the direction of travel, the speed profile or the forced directions of rotation or positions of the objects 48 on the conveying system 46. More than three degrees of freedom are difficult to master with today's computing power, with this being a variable limit in view of high-performance computers.

In an optional seventh step S7, correspondence probabilities of the remaining objects 50a-e to be considered are calculated. These probabilities can also be displayed or output. For example, excluded objects 50a-e are displayed in red, the object or objects 50a-e having the currently greatest correspondence in green and objects 50a-e in doubt in yellow.

A check is then made in a eighth step S8 whether at least one known object 50a-e still remains as a candidate for the identity of the object 48b to be checked. Only when there is no longer any such object 50a-e is a securing signal output via the safety output 34 and thus the corresponding measure is initiated, whether it is only a warning or a safety-directed deactivation of a dangerous machine.

If in a ninth step S9, the total object 48b has passed through the passage opening 40 without all known objects 50a-e having been excluded as possible candidate for its identity, the object 48b has reached the zone 44b as a permitted object in a tenth step S10. The process is then repeated in step S2 with the next object 48b to be checked. Provided the object 48b has not yet passed through the passage opening 40, the monitoring is continued for every other object section which passes through the passage opening in step S4.

1. A distance measuring optoelectronic sensor (10) for mounting at a passage opening (40) which is designed to acquire in real time depth-resolved image information of that object section of an object (48) moved through the passage opening (40) which is in each case located in the detection zone of the sensor (10), having a memory unit (32) which holds a plurality of known objects (50) and their reference contour information as well as having an evaluation unit (30) which is designed to compare the image information and the reference contour information to decide whether an object (48) to be checked and which is located in the passage opening (40) is permitted there, wherein the sensor (10) has a safety output (34) via which a securing signal can be output if the object (48) to be checked is not permitted in the passage opening (40), wherein the evaluation unit (30) is designed to note for each known object (50) stored in the memory unit (32) whether it could be the object (48) to be checked and in each case during the movement of the object (48) through the passage opening (40) to exclude such known objects (50) in which the comparison of the image information and of the reference contour information results in differences beyond a tolerance threshold, with no securing signal being output for so long as at least one known permitted object (50) still comes into consideration for the object (48) to be checked.

2. A sensor (10) in accordance with claim 1, wherein the evaluation unit (30) is designed to exclude known objects (50) as corresponding to the object (48) to be checked in advance in a pre-selection.

3. A sensor (10) in accordance with claim 2, wherein the evaluation unit (30) is designed to make the pre-selection independently of image information of the object (48) to be checked.

4. A sensor (10) in accordance with claim 1, wherein the evaluation unit (30) is designed to determine a degree of correspondence in the comparison of the image information and of the reference contour information.

5. A sensor (10) in accordance with claim 4, wherein the evaluation unit (30) is designed to exclude all other known objects (50) on the exceeding of a minimum similarity threshold of the degree of correspondence for a known object (50).

6. A sensor (10) in accordance with claim 1, wherein the evaluation unit (30) is designed to take account of displacements and/or rotations between the known object (50) and the object (48) to be checked in the comparison of the image information with the reference contour information.

7. A sensor (10) in accordance with claim 1, wherein a speed sensor is provided to determine the movement profile of the object (48) through the passage opening (50); or wherein a movement profile of the object (48) is preset for the evaluation unit (30).

8. A sensor (10) in accordance with claim 1, wherein the evaluation unit (30) is designed for a teaching mode in which objects (48) are moved through the passage opening (40) which are then stored as known objects (50) in the memory unit (32) with reference contour information produced from image information recorded during the movement.

9. A sensor (10) in accordance with claim 1, wherein the sensor (10) has an input for a transit signal via which time sections can be signaled in which no permitted objects (50) are to be expected in the passage opening (40).

10. A sensor (10) in accordance with claim 1, wherein the evaluation unit (30) is designed to store the image information of a respective object section and thus to compose image information of object portions piece-by-piece which have already passed the passage opening (40).

11. A sensor (10) in accordance with claim 1, wherein an object output or a display is provided to output all known objects (50) still to be considered as the object (48) to be checked and/or the most probable known object (50) for an object (48) moved through the passage opening (40).

12. A sensor (10) in accordance with claim 1, which is designed as a laser scanner and has a light transmitter (12) for transmitting a light beam (14) into the passage opening (40), a light receiver (24) for producing a reception signal from the light beam (20) remitted by objects (48) in the passage opening (40) as well as a movable deflection unit (16) for periodically scanning the passage opening (40).

13. A sensor (10) in accordance with claim 1, which is designed as a 3D camera having two image sensors and a stereoscopic unit in which a stereoscopic distance calculation can be carried out from image data of the two image sensors or is designed as a time of flight camera having a light transmitter, an image sensor and a time of light measuring unit by means of which a time of flight between the transmission of a light beam by the light transmitter and the registration of the light beam in the pixel can be determined for each pixel of the image sensor.

14. A sensor (10) in accordance with claim 13, wherein said camera is designed as a stereo camera.

15. A method of securing a passage opening (40) in which depth resolved image information of an object (48) moved through the passage opening (40) is acquired section-wise and in real time with the aid of a distance-measuring optoelectronic sensor (10), wherein the image information is compared with reference contour information of known objects (50) to decide whether an object (48) to be checked and located in the passage opening (40) is permitted there, and wherein a securing signal is output when the object (48) to be checked is not permitted in the passage opening (40), wherein it is noted for each known object (50) whether it could be the object (48) to be checked; and wherein in each case during the movement of the object (48) through the passage opening (40) such known objects (50) are excluded with which the comparison of the image information and of the reference contour information results in differences beyond a tolerance threshold; and wherein no securing signal is output for so long as at least one known permitted object (50) still comes into consideration for the object (48) to be checked.
